(19) United States
(12) Patent Application Publication
(10) Pub. No.: US 2011/0106987 A1
(43) Pub. Date: May 5, 2011

(54) METHOD FOR CONTROLLING A PLURALITY OF PERSONAL COMPUTER HOSTS BY UTILIZING ONLY ONE PERSONAL COMPUTER HOST, AND ASSOCIATED CONTROLLER AND PERSONAL COMPUTER

(76) Inventor: Han-Cheng Huang, Taipei County (TW)

(21) Appl. No.: 12/792,703

(22) Filed: Jun. 2, 2010

(30) Foreign Application Priority Data
Nov. 2, 2009 (TW) 098137115

(51) Int. Cl. G06F 3/00; G06F 13/20; G06F 13/00

(52) U.S. Cl. 710/36; 710/313; 710/107

(57) ABSTRACT

A controller includes a first USB interface, a second USB interface and a control circuit, where the first USB interface is utilized for connecting to a first personal computer host, and the second USB interface is utilized for connecting to a second personal computer host, and the control circuit is coupled to the first and second interfaces. The control circuit receives a control signal from the first personal computer host via the first USB interface, and transmits the control signal to the second personal computer host via the second USB interface to control operations of the second personal computer host.

### BACKGROUND OF THE INVENTION

1. Field of the Invention

The present invention relates to a method for controlling personal computer hosts, and more particularly, to a method for controlling personal computer hosts by using only one personal computer host, and an associated controller and a personal computer.

2. Description of the Prior Art

Many computer hosts can be positioned in a computer room or a data center, but only a few monitors and a corresponding keyboard/mouse are provided for these computers. Therefore, in order to control these computer hosts, the monitor and keyboard/mouse need to be disconnected from one computer and plugged into another computer host, causing inconvenience and trouble to a user.

To solve these problems, a prior art KVM (Keyboard, Video/Visual display unit, and Mouse) switch is provided, which can be installed between a keyboard/monitor/mouse and a plurality of computer hosts, so the user can simply determine which computer host is to be connected to the keyboard/monitor/mouse by using the KVM switch. However, even by using this switch, the user cannot use a single keyboard/monitor/mouse to control the plurality of computer hosts easily without switching the KVM switch, therefore, the prior art KVM switch does not significantly increase the convenience to the user.

### SUMMARY OF THE INVENTION

It is therefore an objective of the present invention to provide a method for controlling a plurality of personal computer hosts by using only one personal computer host, and an associated controller and personal computer, to solve the above-mentioned problems.

According to one embodiment of the present invention, a controller comprises a first USB interface, a second USB interface and a control circuit, where the first USB interface is utilized for connecting with a first personal computer host, and the second USB interface is utilized for connecting with a second personal computer host, and the control circuit is coupled to the first and second interfaces. The control circuit receives a control signal from the first personal computer host via the first USB interface, and transmits the control signal to the second personal computer host via the second USB interface to control operations of the second personal computer host.

According to another embodiment of the present invention, a method for controlling a plurality of personal computer hosts by utilizing a single personal computer host is disclosed, where the plurality of personal computer hosts include a first personal computer host and a second personal computer host. The method comprises: receiving a control signal from the first personal computer host via a first USB interface; and transmitting the control signal to the second personal computer host via a second USB interface to control operations of the second personal computer host.

According to another embodiment of the present invention, a personal computer is disclosed. The personal computer comprises a monitor, a personal computer host and at least one peripheral input device, where the personal computer host comprises a storage medium storing a computer program. When the personal computer host executes the computer program, the personal computer executes the following steps: at a first state, receiving a control signal from the peripheral input device, and controlling operations of the personal computer host according to the control signal; and at a second state, receiving the control signal from a peripheral input device, and transmitting the control signal to another personal computer host via a USB interface to control operations of the other personal computer host.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a system which comprises a plurality of personal computer hosts according to one embodiment of the present invention.

FIG. 2 is a diagram illustrating the controller shown in FIG. 1 according to one embodiment of the present invention.

FIG. 3 is a flowchart of the operations of the system shown in FIG. 1 according to one embodiment of the present invention.

### DETAILED DESCRIPTION

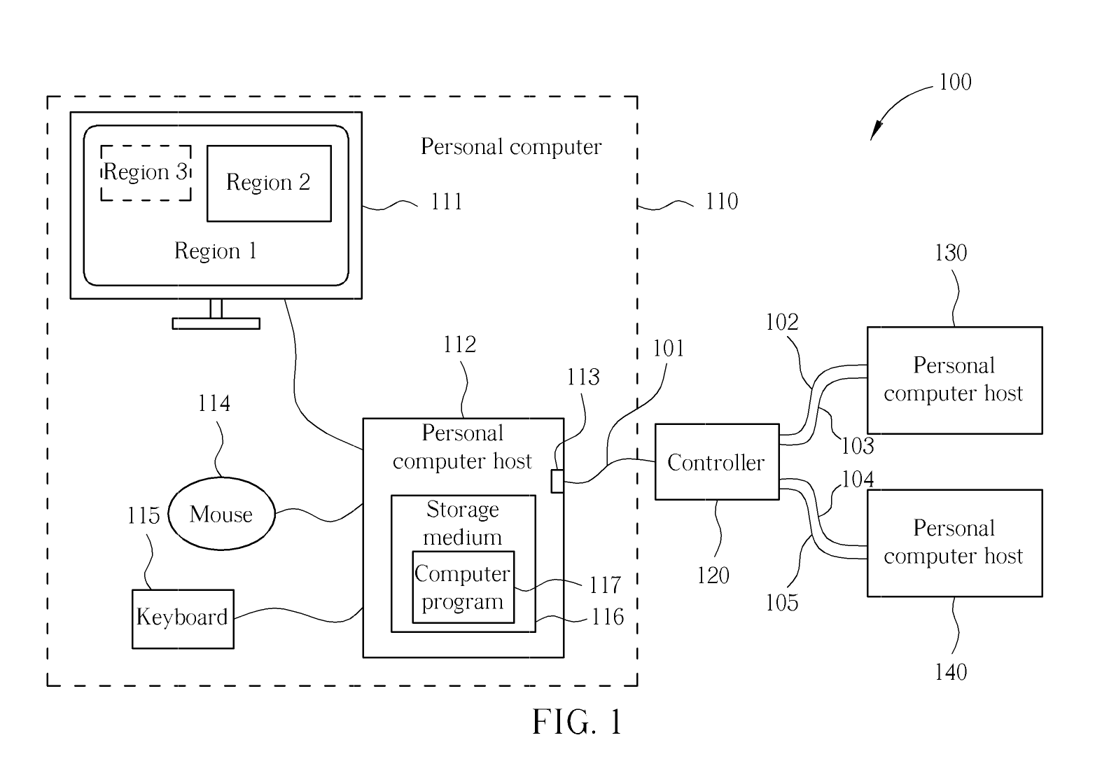

Please refer to FIG. 1. FIG. 1 is a diagram illustrating a system 100 which comprises a plurality of personal computer hosts according to one embodiment of the present invention. As shown in FIG. 1, the system 100 includes a personal computer 110, a controller 120, at least one computer host (in this embodiment, there are two personal computer hosts 130 and 140), where the personal computer 110 comprises a monitor 111, a personal computer host 112, a USB (Universal Serial Bus) interface 113, at least one peripheral input device (in this embodiment, there is a mouse 114 and a keyboard 115), and a storage medium 116 storing a computer program 117. In addition, the controller 120 is connected to the USB interface 113 of the personal computer host 112 via a USB transmission line 101, and the controller 120 is connected to the personal computer host 130 via a USB transmission line 102 and a video signal transmission line (in this embodiment, a VGA (Video Graphics Array) transmission line 103 serves as the video signal transmission line), and the controller 120 is connected to the personal computer host 140 via a USB transmission line 104 and a video signal transmission line (in this embodiment, a VGA transmission line 105 serves as the video signal transmission line). Please note that the personal computer hosts 130 and 140 can be personal computers which include peripheral devices, such as notebooks or smartbooks/netbooks.

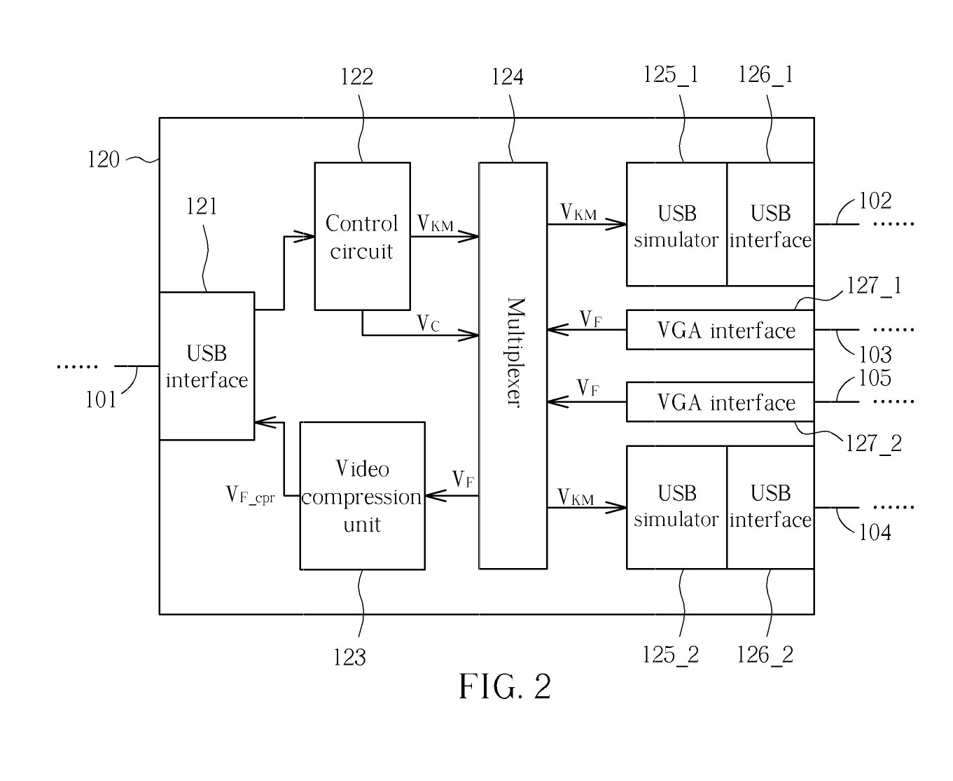

Please refer to FIG. 2. FIG. 2 is a diagram illustrating the controller 120 shown in FIG. 1 according to one embodiment of the present invention. As shown in FIG. 2, the controller 120 comprises a USB interface 121, a control circuit 122, a video compression unit 123, a multiplexer 124, USB simulators 125_1 and 125_2, USB interfaces 126_1 and 126_2, and video interfaces (such as VGA interfaces) 127_1 and 127_2.

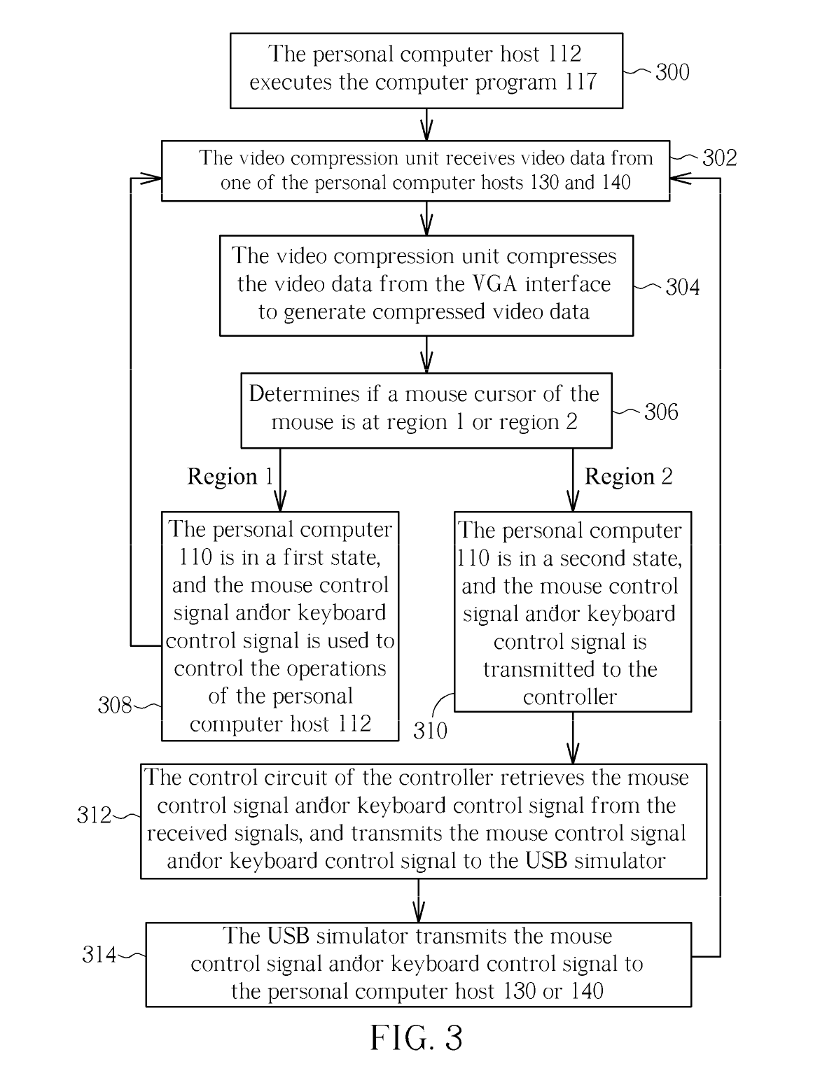

Please refer to FIGS. 1-3 together. FIG. 3 is a flowchart of the operations of the system 100 according to one embodiment of the present invention. Please note that, provided the results are substantially the same, the steps are not limited to be executed according to the exact order shown in FIG. 3. Referring to FIG. 3, the flow is described as follows:

In Step 300, the personal computer host 112 executes the computer program 117. Then, in Step 302, the video compression unit 123 of the controller 120 receives video data from one of the personal computer hosts 130 and 140. In other words, the user can use the computer program 117 of the personal computer host 112 or a switch (not shown) of the controller 120 to make the controller 120 selectively receive the video data from the personal computer host 130 or 140. In detail, if the personal computer host 130 is selected, the control circuit 122 of the controller 120 will transmit at least one control signal Vc to the multiplexer 124 to ensure that only the parallel video data V_{F} generated from the VGA interface 127_1 can be transmitted to the video compression unit 123. The VGA interface 127_1 is utilized for receiving serial video data from the personal computer host 130 via the USB transmission line 103, and converting the serial video data into the parallel video data V_{F}. For example, the VGA interface 127_1 can convert the bit-based serial video data into the byte-based parallel video data V_{F} to satisfy the standard of the USB interface 121. Similarly, if the personal computer host 140 is selected, the control circuit 122 of the controller 120 will transmit at least the control signal Vc to the multiplexer 124 to ensure that only the parallel video data V_{F} generated from the VGA interface 127_2 can be transmitted to the video compression unit 123. The VGA interface 127_2 is utilized for receiving serial video data from the personal computer host 140 via the USB transmission line 105, and converting the serial video data into the parallel video data V_{F}.

Then, in Step 304, the video compression unit 123 compresses the video data V_{F} from the VGA interface 127_1 or 127_2 to generate compressed video data V_{F}_{_{—}}_{cpr}, and the compressed video data V_{F}_{_{—}}_{cpr} is transmitted to the personal computer host 112 via the USB interface 121 and the USB transmission line 101, and is displayed on region 2 of the monitor 111. In other words, the video data of the personal computer host 130 or 140 is displayed on region 2 of the monitor 111, and video data of the personal computer host 112 is displayed on region 1 of the monitor 111. Please note that the video compression unit 123 can be removed if the bandwidth is sufficient (e.g., USB 3.0 is used) for directly transmitting the video data V_{F} from the VGA interface 127_1 or 127_2 to the personal computer host 112 via the USB interface 121 and USB transmission line 101.

In Step 306, the computer program 117 determines if a mouse cursor of the mouse 114 is at the region 1 or the region 2 of the monitor 111. If the mouse cursor of the mouse 114 is at region 1, the flow enters Step 308; and if the mouse cursor of the mouse 114 is at region 2, the flow enters Step 310.

In Step 308, the personal computer 110 is in a first state, the personal computer host 112 receives a mouse control signal from the mouse 114 and/or a keyboard control signal from the keyboard 115, and the mouse control signal and/or keyboard control signal is used to control the operations of the personal computer host 112.

In Step 310, the personal computer 110 is in a second state, the personal computer host 112 receives a mouse control signal from the mouse 114 and/or a keyboard control signal from the keyboard 115, and transmits the mouse control signal and/or keyboard control signal V_{KM} and the other related signal (e.g., a command signal for indicating which personal computer host the controller 120 should transmit the mouse control signal and/or keyboard control signal V_{KM} to) to the controller 120 via the USB interface 113 and the USB transmission line 101.

In Step 312, the control circuit 122 of the controller 120 retrieves the mouse control signal and/or keyboard control signal V_{KM} from the received signals, and transmits the mouse control signal and/or keyboard control signal V_{KM} to the USB simulator 125_1 or 125_2 via the multiplexer 124. It is noted that, if the personal computer host 130 is selected in Step 302, the mouse control signal and/or keyboard control signal V_{KM} is transmitted to the USB simulator 125_1 via the multiplexer 124; and if the personal computer host 140 is selected in Step 302, the mouse control signal and/or keyboard control signal V_{KM} is transmitted to the USB simulator 125_2 via the multiplexer 124.

In Step 314, the USB simulator 125_1 or 125_2 transmits the mouse control signal and/or keyboard control signal V_{KM} to the personal computer host 130 or 140 via the USB interface 126_1 or 126_2. In detail, taking the USB simulator 125_1 as an example, the USB simulator 125_1 generates a mouse and/or keyboard simulation data, where this simulation data is for simulating that a mouse and/or keyboard is connected to the personal computer host 130 via the USB transmission line 102, and the personal computer host 130 is controlled by the simulated mouse and/or keyboard. Then, after the USB simulator 125_1 receives the mouse control signal and/or keyboard control signal V_{KM}, the USB simulator 125_1 embeds the mouse control signal and/or keyboard control signal V_{KM} into the mouse and/or keyboard simulation data, and transmits embedded mouse/keyboard simulation data to the personal computer host 130 via the USB interface 126_1 and the USB transmission line 102. Similarly, the USB simulator 125_2 generates a mouse and/or keyboard simulation data, where this simulation data is for simulating that a mouse and/or keyboard is connected to the personal computer host 140 via the USB transmission line 104, and the personal computer host 140 is controlled by the simulated mouse and/or keyboard. Then, after the USB simulator 125_2 receives the mouse control signal and/or keyboard control signal V_{KM}, the USB simulator 125_2 embeds the mouse control signal and/or keyboard control signal V_{KM} into the mouse and/or keyboard simulation data, and transmits embedded mouse/keyboard simulation data to the personal computer host 140 via the USB interface 126_2 and the USB transmission line 104.

Referring to the above-mentioned Steps 300-314, the user can use only one mouse 114 and one keyboard 115 to control the personal computer host 130 or 140 and 112 at the same time, and therefore the convenience to the user is increased. In addition, because the USB interface is provided to connect the personal computer host 112 and the personal computer host 130 or 140, the design of the controller 120 is simpler and the manufacturing cost of the controller 120 is decreased.

It is noted that, in the embodiments shown in FIG. 1 and FIG. 2, the personal computer host 112 is coupled to the personal computer hosts 130 and 140 via the controller 120, and the controller 120 includes two VGA interfaces and two USB simulators. In other embodiments, however, the personal computer host 112 can be coupled to more than two personal computer hosts via the controller 120, and the controller 120 includes more than two VGA interfaces and USB simulators. These alternative designs should also fall within the scope of the present invention.

In addition, the video compression unit 123 shown in FIG. 2 is an optional device, and the video compression unit 123 can be removed from the controller 120 if the bandwidth of the USB interfaces 113 and 121 are sufficient for directly transmitting the video data V_{F} from the VGA interface 127_1 or 127_2 to the personal computer host 112.

In addition, in another embodiment of the present invention, the USB simulator 125_2, the USB interface 126_2, the VGA interface 127_2 and the multiplexer 124 can be removed from the controller 120, and the mouse control signal and/or keyboard control signal V_{KM} generated from the control circuit 122 is directly inputted into the USB simulator 125_1, and the video compression unit 123 directly receives the parallel video data V_{F} from the VGA interface 127_1. In other words, the personal computer host 112 is coupled to a single personal computer host via the controller 120. This alternative design also falls within the scope of the present invention.

In addition, in the embodiment shown in FIG. 2, the user can use the mouse 114 and the keyboard 115 to control the personal computer host 112 and one of the personal computers 130 and 140. That is, the user cannot control the personal computer hosts 130 and 140 at the same time. In another embodiment of the present invention, however, the controller 120 can be designed for receiving the video data from the personal computer hosts 130 and 140 at the same, and the video compression unit compresses the video data from the personal computer hosts 130 and 140 and transmits the compressed video data to the personal computer host 112. Then, the video data of the personal computers 130 and 140 are displayed on region 2 and region 3 of the monitor 111 (shown in FIG. 3), respectively. In addition, if the mouse cursor of the mouse 114 is at the region 1 of the monitor 111, the personal computer host 112 receives the mouse control signal from the mouse 114 and/or keyboard control signal from the keyboard 115, and the personal computer host 112 is controlled by the mouse control signal and/or keyboard control signal; if the mouse cursor of the mouse 114 is at the region 2 of the monitor 111, the mouse control signal and/or keyboard control signal is transmitted to the personal computer host 130 via the personal computer host 112 and the controller 120, to control the operations of the personal computer host 130; and if the mouse cursor of the mouse 114 is at the region 3 of the monitor 111, the mouse control signal and/or keyboard control signal is transmitted to the personal computer host 140 via the personal computer host 112 and the controller 120, to control the operations of the personal computer host 140.

In the above embodiment in which the controller 120 can receive the video data from the personal computer hosts 130 and 140 at the same time and transmit the received video data of the personal computer hosts 130 and 140 to the personal computer host 112, the control circuit 122 can use a round robin mechanism to control the multiplexer 124 to sequentially receive the parallel video data V_{F} from the VGA interfaces 127_1 and 127_2. In detail, during a first period, the multiplexer 124 switches on a channel between the VGA interface 127_1 and the video compression unit 123, and the video compression unit 123 receives the video data V_{F} from the VGA interface 127_1; then, during a second period immediately following the first period, the multiplexer 124 switches on a channel between the VGA interface 127_2 and the video compression unit 123, and the video compression unit 123 receives the video data V_{F} from the VGA interface 127_2; and then, during a third period immediately following the second period, the multiplexer 124 switches on the channel between the VGA interface 127_1 and the video compression unit 123, and the video compression unit 123 receives the video data V_{F} from the VGA interface 127_1 . . . and so on.

Briefly summarized, in the present invention, the user can use only one mouse/keyboard to control a plurality of personal computer hosts, and the convenience to the user is thereby increased. In addition, because the USB interface is provided to connect the personal computer hosts, the design of the controller is simpler and the manufacturing cost of the controller is decreased.

Those skilled in the art will readily observe that numerous modifications and alterations of the device and method may be made while retaining the teachings of the invention.

What is claimed is:

1. A controller, comprising:
a first USB interface, for connecting to a first personal computer host;
a second USB interface, for connecting to a second personal computer host; and
a control circuit, coupled to the first and the second USB interfaces;
wherein the control circuit receives a control signal from the first personal computer host via the first USB interface, and transmits the control signal to the second personal computer host via the second USB interface to control operations of the second personal computer host.

2. The controller of claim 1, further comprising:
a video interface;
wherein the control circuit receives video data from the second personal computer host via the video interface, and transmits the video data to the first personal computer host via the first USB interface.

3. The controller of claim 1, further comprising:
a video interface; and
a video compression unit, coupled to the video interface and the first USB interface;
wherein the video compression unit receives video data from the second personal computer host via the video interface, compresses the video data to generate compressed video data, and transmits the compressed video data to the first personal computer host via the first USB interface.

4. The controller of claim 1, further comprising:
a third USB interface, for connecting to a third personal computer host;
wherein the control circuit is coupled to the third USB interface, and selectively transmits the control signal to the third personal computer host via the third USB interface to control operations of the third personal computer host, or transmits the control signal to the second personal computer host via the second USB interface to control the operations of the second personal computer host.

5. The controller of claim 4, wherein the control circuit further receives a command signal from the first personal computer host, and determines to transmit the control signal to the second USB interface or the third USB interface according to the command signal.

6. The controller of claim 1, wherein the control signal is a keyboard control signal.

7. The controller of claim 1, wherein the control signal is a mouse control signal.

8. A method for controlling a plurality of personal computer hosts by utilizing a single personal computer host, where the plurality of personal computer hosts comprise a first personal computer host and a second personal computer host, the method comprising:
receiving a control signal from the first personal computer host via a first USB interface; and
transmitting the control signal to the second personal computer host via a second USB interface to control operations of the second personal computer host.

9. The method of claim 8, further comprising:
receiving video data from the second personal computer host via a video interface; and
transmitting the video data to the first personal computer host via the first USB interface.

10. The method of claim 8, further comprising:
receiving video data from the second personal computer host via a video interface;
compressing the video data to generate compressed video data; and
transmitting the compressed video data to the first personal computer host via the first USB interface.

11. The method of claim 8, wherein the plurality of personal computer hosts further include a third personal computer host, and the method further comprises:
selectively transmitting the control signal to the third personal computer host via a third USB interface to control operations of the third personal computer host, or transmitting the control signal to the second personal computer host via the second USB interface to control the operations of the second personal computer host.

12. The method of claim 11, further comprising:
receiving a command signal from the personal computer host; and
determining to transmit the control signal to the second USB interface or the third USB interface according to the command signal.

13. The method of claim 8, wherein the control signal is a keyboard control signal.

14. The method of claim 8, wherein the control signal is a mouse control signal.

15. A personal computer comprising a monitor, a personal computer host and at least one peripheral input device, the personal computer host comprising a storage medium storing a computer program, wherein when the personal computer host executes the computer program, the personal computer host executes the following steps:
in a first state, receiving a control signal from the peripheral input device, and controlling the personal computer host according to the control signal; and
in a second state, receiving the control signal from the peripheral input device, and transmitting the control signal to another personal computer host via a USB interface to control operations of the other personal computer host.

16. The personal computer of claim 15, wherein the personal computer host further receives video data from the another personal computer host via the USB interface, and displays the video data on the monitor of the personal computer.

17. The personal computer of claim 15, wherein the peripheral input device is a keyboard, and the control signal is a keyboard control signal.

18. The personal computer of claim 15, wherein the peripheral input device is a mouse, and the control signal is a mouse control signal.

19. The personal computer of claim 18, wherein the personal computer host further receives video data from the other personal computer host via the USB interface, and displays the video data on the monitor of the personal computer; a first region of the monitor shows video data provided by the personal computer host, and a second region of the monitor shows the video data from the other personal computer host; and when a mouse cursor of the mouse is at the first region, the personal computer is in the first state, and when the mouse cursor of the mouse is at the second region, the personal computer is in the second state.
